(19) United States
(12) Patent Application Publication
(10) Pub. No.: US 2024/0180225 A1
(43) Pub. Date: Jun. 6, 2024

(54) WATER-BASED CUTTING MECHANISM FOR PITTED FRUIT

(71) Applicant: Johnson Foods, Inc., Sunnyside, WA (US)

(72) Inventor: Gary Edgar Johnson, Sunnyside, WA (US)

(21) Appl. No.: 18/076,212

(22) Filed: Dec. 6, 2022

(51) Int. Cl. A23N 4/06

(52) U.S. Cl. CPC A23N 4/06

(57) ABSTRACT

A processing system that may halve, dice, slice or otherwise cut a piece of fruit in such a manner as to enable pit detection in the piece of fruit. Once the piece of fruit has undergone a pitting process, a cutting process and mechanism prevents a pit from shattering or breaking during the cutting process and cuts the fruit in such a way that the presence of a pit may be easily detected.

### BACKGROUND

Various fruits contain pits. However, unlike fruits that are sold in fresh markets, fruit that is frozen or canned, is typically “pitted” or otherwise processed in order to have the pit removed prior to packaging the fruit for subsequent sale. However, detecting whether a pit has actually been removed from a piece of fruit is a labor-intensive process. Accordingly, it would be beneficial to have a fruit processing process that enables a pit to be more easily detected.

### SUMMARY

This disclosure generally relates to halving, dicing, slicing or otherwise cutting a piece of fruit in such a manner as to enable pit detection in the piece of fruit. For example, once a piece of fruit (e.g., a cherry) has undergone a pitting process, the present application describes a cutting process and mechanism that prevents a pit from shattering or breaking during the cutting process and cuts the fruit in such a way that the presence of a pit may be more easily detected when compared with current solutions.

Accordingly, disclosed herein is a method for cutting a piece of fruit. In an example, the method includes receiving a piece of fruit from a delivery mechanism. The piece of fruit is received by the delivery mechanism based on the piece of fruit undergoing a fruit pitting process. The delivery mechanism provides the piece of fruit to a water-based fruit cutting mechanism. In an example, the water-based fruit cutting mechanism includes a water blade having an associated diameter and an associated pressure. The water-based fruit cutting mechanism cuts the piece of fruit. The diameter and pressure of the water blade is configured such that the water blade cuts the flesh of the piece of fruit and not a pit that may remain within the piece of fruit after the piece of fruit has undergone the fruit pitting process.

The present disclosure also describes a water-based fruit cutting system. The water-based fruit cutting system includes a water-based fruit cutting mechanism. The water-based fruit cutting mechanism is associated with a fruit delivery mechanism. Additionally, the water-based fruit cutting mechanism has a diameter and a pressure. In an example, a receptacle is associated with the water-based fruit cutting mechanism. The receptacle is configured to receive fruit that has been cut or sliced by the water-based fruit cutting mechanism after the fruit delivery mechanism provides the fruit to the water-based fruit cutting mechanism.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a system for cutting the flesh of a piece of fruit that has undergone a pitting process in order to detect the presence of a pit according to an example.

FIG. 2 illustrates a method for cutting the flesh of a piece of fruit that has undergone a pitting process in order to detect the presence of a pit according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Many fruits, such as cherries, olives, peaches, etc., contain pits. When these fruits are sold on the fresh market, the consumer, typically an individual buying the fruit at a supermarket, a fruit stand or the like, expects or knows that the fruit should or will contain a pit. For example, if the individual buys a bag of fresh cherries at the supermarket, the individual knows that each cherry will contain a pit. Although a cherry is specifically mentioned, the concepts described herein may be used in any food that contains a pit or other type of seed that is to be removed for processing.

However, not all fruits that contain pits are sold on the fresh market. In some cases, these fruits may be processed or pitted, packaged and/or frozen and provided to various food manufacturers. These food manufacturers typically require that the pit is entirely removed from each piece of fruit. For example, a warehouse may specialize in pitting fresh cherries. Once the cherries are pitted (typically using a pitting machine), the cherries are packaged, frozen and subsequently sold to food manufacturers. The food manufacturers may use the cherries to create cherry yogurt, cherry ice cream and other food items.

Typically, cherries are pitted using machines that push, squeeze or punch the pit out of a cherry. For example, during a pitting process, the pit is pushed out through the bottom of the cherry while the cherry remains relatively whole. Once the cherry is pitted, the cherries continue down a manufacturing line for further processing. In some examples, further processing of the cherry includes a cutting or halving process in which the cherry is sliced into two or more pieces. The halving process is typically performed by a halving machine with spinning metal blades. As cherries are fed into the halving machine, the cherries contact the spinning blades and are cut in half.

A typical pitting machine may pit approximately 1800 pounds of cherries per hour and those cherries may subsequently be halved by the halving machine. In some cases, the pitting machine does not remove the pit from a cherry. In other cases, the punching process of the pitting machine may crack or break the pit into one or more fragments. In some situations, the one or more fragments of the pit may remain in the cherry. If a cherry still has a pit when it is subsequently halved, the halving machine may break or smash the pit into multiple pieces and some of the pieces, or the pit itself, may remain in the cherry. Thus, detecting and removing pits is a time and labor intensive process.

Accordingly, aspects of the present disclosure describe a system and method for halving, cutting, slicing or dicing a piece of pitted fruit such that if a pit remains in the piece of fruit, the pit is not shattered or broken during the halving process. In addition, the system and method described herein allows for pieces of fruit having pits after a pitting and/or halving process to be more easily detected when compared to current processes and systems.

The water-based fruit cutting mechanism of the present disclosure is configured to cut the flesh of a piece of fruit, but not a pit, should a pit (or a portion of a pit) remain at least partially in the piece of fruit after the piece of fruit has undergone an automated (or manual) pitting process. The water-based fruit cutting mechanism includes a water blade having a dimension and an associated pressure. As will be explained in greater detail below, the water-based fruit cutting mechanism may receive a piece of fruit (or many pieces of fruit) after the piece of fruit has undergone a pitting process. As the piece of fruit is received by the water-based fruit cutting mechanism, the water blade cuts the piece of fruit and the piece of fruit can be further processed. The dimension and/or the pressure of the water blade is configured such that the flesh of the piece of fruit will be cut, but any remaining pit within the piece of fruit will not be cut.

As pieces of fruit exit the water-based fruit cutting mechanism, pieces of fruit that still contain a pit (or a portion of a pit) will remain whole or substantially whole. For example, a piece of fruit with a pit will not be completely halved by the water-based fruit cutting mechanism. For example, the presence of the pit will prevent the halves of the sliced piece of fruit from fully separating. As such, any whole or substantially whole piece of fruit may be identified as having a pit (or a partial pit) and/or be removed from further processing.

For example, as cherries exit a pitting machine, the cherries may be fed (e.g., by a conveyer belt or other delivery mechanism) to the water-based fruit cutting mechanism. In an example, the water-based fruit cutting mechanism is gravity-fed. Thus, as the pieces of fruit move along the delivery mechanism to the end, the pieces of fruit fall off the end of the delivery mechanism and into the water-based fruit cutting mechanism. As the pieces of fruit fall into and/or through the water-based fruit cutting mechanism, one or more water blades cut each of the pieces of fruit.

The cut pieces of fruit are then received on a second conveyer belt or delivery mechanism where each piece of fruit may be inspected. In an example, the inspection may be completed by an artificial intelligence system and/or vision system that compares sizes of the pieces of fruit with an expected size. If the size of the fruit is greater than a size threshold, the artificial intelligence system may preliminarily determine that the piece of fruit still contains a pit.

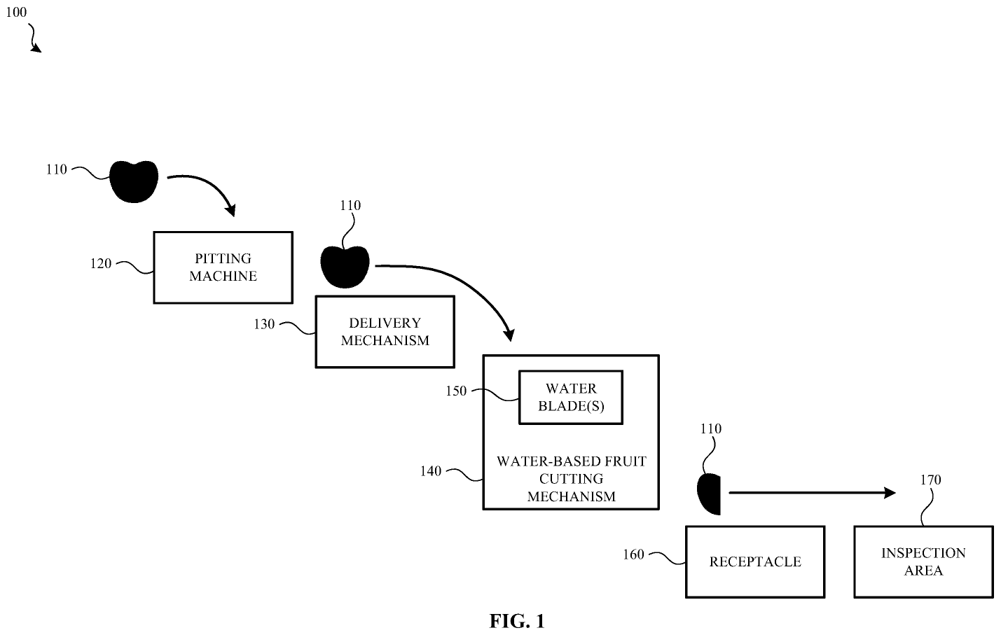

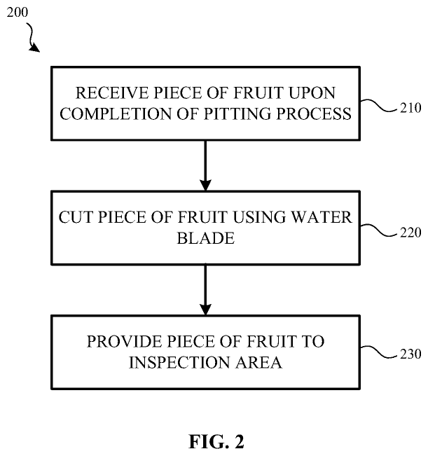

These and other concepts will be described in greater detail below with respect to FIG. 1-FIG. 2.

FIG. 1 illustrates a system 100 for cutting the flesh of a piece of fruit that has undergone a pitting process in order to detect the presence of a pit according to an example. For example, the system 100 may be used for processing (e.g., cutting, dicing, slicing, halving) a piece of fruit. Additionally, the system 100 may process the piece of fruit in a such a way as to enable a pit to be more easily detected and/or identified when compared with current solutions. In the examples described herein, the piece of fruit is a cherry 110. Although a cherry 110 is specifically mentioned, the system 100 may be used with any piece of fruit that contains a pit or seed that is to be removed during processing and/or for further processing.

The system 100 may include a pitting machine 120. The pitting machine 120 may be a punch pitting machine, a roller pitting machine or any other automated pitting machine that removes a pit from a piece of fruit. In the example shown in FIG. 1, the pitting machine 120 receives a cherry 110. Although a single cherry 110 is shown, it is contemplated that the pitting machine 120 receives and pits multiple cherries simultaneously or substantially simultaneously.

Once the cherry 110 has undergone a pitting process, the cherry 110 is provided to a delivery mechanism 130. The delivery mechanism 130 may be a conveyer belt or other mechanism that moves the cherry from an exit point of the pitting machine 120 to an entry point of a water-based fruit cutting mechanism 140.

The water-based fruit cutting mechanism 140 may include one or more water blades 150. The water blades may be spaced, arranged or otherwise positioned such that when a cherry 110 enters or is otherwise received by the water-based fruit cutting mechanism 140, the cherry 110 contacts at least one of the water-blades 150. In an example, the position of each of the water blades may be adjustable (e.g., based on a size of the piece of fruit, the dimensions of the piece of fruit, a type of the piece of fruit, etc.).

Each water blade 150 of the water-based fruit cutting mechanism 140 may output a particular water pressure and/or have a particular dimension. In one example, the amount of pressure output by the water blade 150 is between approximately ten thousand pounds per square inch and seventeen thousand pounds per square inch. In another example, the pressure provided by each water blade 150 is approximately fifteen thousand pounds per square inch. In an example, the diameter of each water blade 150 is between approximately three micrometers and approximately seven micrometers. In another example, the diameter of each water blade 150 is approximately five micrometers. Although specific values have been given, other values may be used.

In an example, the water blades 150 may be horizontally and/or vertically oriented/arranged. The orientation of the water blades 150 may be based on a way in which the cherry 110 is provided to the water-based fruit cutting mechanism 140. In one example, the cherry 110 may be provided to and/or through the water-based fruit cutting mechanism 140 via the delivery mechanism 130. For example, each cherry 110 may enter the water-based fruit cutting mechanism 140 via a tray or cup that holds individual (or multiple) pieces of fruit. As the tray or cup moves through the water-based fruit cutting mechanism vertical oriented water blades 150 that are aligned with the tray or cup may cut the flesh of the cherry 110.

In another example, the cherry 110 may enter the water-based fruit cutting mechanism 140 using a gravity-based method. For example, the delivery mechanism 130 may provide the cherry 110 to an entry point of the water-based fruit cutting mechanism 140 and drop the cherry 110 in to the water-based fruit cutting mechanism. As the cherry 110 moves through the water-based fruit cutting mechanism vertically and/or horizontally arranged water blades 150 may cut the flesh of the cherry 110 as the cherry 110 falls though the water-based cutting mechanism 140 and into a receptacle 160 (or other receiving area and/or second delivery mechanism).

Although specific methods of delivery and subsequent cutting of the cherry 110 are explained, other delivery methods are contemplated. Regardless of the arrangement of the water blades 150 and the methods of delivery to the water-based fruit cutting mechanism 140, the water blades 150 will cut the flesh of the cherry 110 but not cut, smash or crack a pit within the cherry 110 should a pit be present. As indicated above, this is unlike present solutions in which spinning blades of halving machine typically shatter a pit that remains in a cherry 110 thereby making it difficult to detect the presence of a pit and subsequently remove the pit, or a portion of the pit, from processed cherries.

Once the cherry 110 has been cut, the cherry 110 is provided to an inspection area 170. While in the inspection area, each cherry is inspected to determine whether the cherry was entirely or fully cut (e.g., whether different halves or pieces of the cherry are or are not fully separated) by the water blade 150. If a cherry was not entirely or fully cut (e.g., cut in half) by a water blade 150, the cherry 110 may have a pit. For example, since the pressure and diameter of the water blade 150 cuts the flesh of the cherry 110 and not the pit, if a cherry is whole or substantially whole, a pit most likely remains in the cherry 110. As such, the cherry 110 can be removed from further processing. If the cherry 110 was cut, the pit was removed from the cherry 110 and the cherry 110 can be processed further.

In an example, the inspection area may include a computer vision system that visually identifies whole or substantially whole cherries.

FIG. 2 illustrates a method 200 for cutting the flesh of a piece of fruit that has undergone a pitting process in order to detect the presence of a pit according to an example. Using the method 200 described below, the presence of a pit in a piece of fruit may be more easily detected when compared with current pit detection techniques. In an example, the method 200, or portions of method 200, are performed by a water-based fruit cutting mechanism such as, for example, water-based fruit cutting mechanism 140 (FIG. 1).

The method 200 begins when a piece of fruit is received (210) by a water-based cutting mechanism. The piece of fruit may be provided to the water-based mechanism by a delivery mechanism upon the piece of fruit undergoing and/or completing a pit removal process (e.g., a pitting process performed by a pitting machine).

Once the piece of fruit has been received by the water-based cutting mechanism, one or more water blades of the water-based cutting mechanism cuts (220) the piece of fruit. In one example, the amount of pressure output by the water blade is between approximately ten thousand pounds per square inch and seventeen thousand pounds per square inch. In another example, the pressure provided by each water blade is approximately fifteen thousand pounds per square inch. In an example, the diameter of each water blade is between approximately three micrometers and approximately seven micrometers. In another example, the diameter of each water blade 150 is approximately five micrometers. Although specific values have been given, other values may be used. For example, the pressure and/or the diameter are configured such that the water blade cuts the flesh of the fruit but does not cut and/or crack a pit that may be present in the piece of fruit upon the piece of fruit exiting a pitting machine.

Once the water blade has cut the piece of fruit, the piece of fruit is provided (230) to an inspection area. If a pit remains in the piece of fruit, the presence of the pit may not allow the piece of fruit to be separated into two (or more) halves. Since the water blade did not cut the pit, whole (or substantially whole) pieces of fruit may be easily identified as having a pit or a pit fragment. For example, pieces of fruit without a pit will be in halves while pieces of fruit with a pit will remain whole or substantially whole. Thus, pieces of fruit with pits may be visually identifiable.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. In addition, each of the operations described above may be executed in any order. For example, one operation may be performed before another operation. Additionally, one or more of the disclosed operations may be performed simultaneously or substantially simultaneously.

Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
receiving, after a fruit pitting process, a piece of fruit on a delivery mechanism;
causing the delivery mechanism to provide the piece of fruit to a water-based fruit cutting mechanism, the water-based fruit cutting mechanism comprising a water blade having an associated diameter and an associated pressure; and
causing the water-based fruit cutting mechanism to cut the piece of fruit whereby the water-based fruit cutting mechanism cuts the piece of fruit and not a pit that remains after the fruit pitting process.

2. The method of claim 1, further comprising causing the pit to be detected based, at least in part, on a size of the piece of fruit after the piece of fruit has been subjected to the water-based fruit cutting mechanism.

3. The method of claim 1, wherein the diameter of the water blade is approximately five micrometers.

4. The method of claim 1, wherein the pressure of the water blade is approximately fifteen thousand pounds per square inch.

5. The method of claim 1, wherein the delivery mechanism comprises a conveyer belt.

6. The method of claim 1, wherein causing the water-based fruit cutting mechanism to cut the piece of fruit comprises causing the piece of fruit to:
fall from an end of the delivery mechanism;
contact the water-based fruit cutting mechanism; and
be received into a receptacle.

7. The method of claim 6, further comprising causing the piece of fruit to enter an inspection process when the piece of fruit is received into the receptacle.

8. A water-based fruit cutting system, comprising:
a water-based fruit cutting mechanism associated with a fruit delivery mechanism, the water-based fruit cutting mechanism having a diameter and a pressure; and
a receptacle associated with the water-based fruit cutting mechanism and configured to receive fruit that has been sliced by the water-based fruit cutting mechanism after the fruit delivery mechanism provides the fruit to the water-based fruit cutting mechanism.

9. The water-based fruit cutting system of claim 8, wherein the diameter of the water-based fruit cutting mechanism is approximately five micrometers.

10. The water-based fruit cutting system of claim 8, wherein the pressure of the water-based fruit cutting mechanism is approximately fifteen thousand pounds per square inch.

11. The water-based fruit cutting system of claim 8, wherein the fruit delivery mechanism is a conveyer belt.

12. The water-based fruit cutting system of claim 8, further comprising an observation area associated with the receptacle, the observation area for identifying whether the fruit contains a pit.
